(19) United States
(12) Patent Application Publication
(10) Pub. No.: US 2025/0258976 A1
(43) Pub. Date: Aug. 14, 2025

(54) Designing Variable Strength Well Casings

(71) Applicant: Saudi Arabian Oil Company, Dhahran (SA)

(72) Inventors: Nada M. Bokhamsin, Dammam (SA); Sara Almulhim, Dhahran (SA); Moath I. Gazlan, Khobar (SA); Omar A. Dajani, Al Khobar (SA); Denis Sabitov, Moscow (RU); Hussain AlBahrani, Qatif (SA)

(21) Appl. No.: 18/436,847

(22) Filed: Feb. 8, 2024

(51) Int. Cl. G06F 30/23; G06F 30/17; G06F 119/02; G06F 119/14

(52) U.S. Cl. CPC G06F 30/23; G06F 30/17; G06F 2119/02; G06F 2119/14

(57) ABSTRACT

Systems and methods for designing variable strength casings for a wellbore in a subsurface formation include obtaining wireline log data and core sample data from the wellbore; determining stress and strain distributions along the wellbore based on the wireline log data and core sample data; determining reservoir displacement of a reservoir in the subsurface formation based on the stress and strain distributions. Locations of potential failure of well casings in the wellbore are identified based on the stress and strain distributions and the reservoir displacement; and a variable strength casing design for the wellbore is determined with higher strength casing in the locations of potential failure relative to casing in other locations in the wellbore.

### TECHNICAL FIELD

The present disclosure relates to well casings for a well drilled in a subsurface formation.

### BACKGROUND

Well casings include linings installed in a well after the well is drilled. Well casings include pipes (e.g., steel pipes) that extend through the depth of the well providing stabilization to the well. Well casings also provide a flow path for fluids produced from the well to be extracted at the surface. Well casings are typically cemented in place after being placed in the well.

### SUMMARY

This disclosure describes systems and methods for designing variable strength casings for a wellbore in a subsurface formation. Field sampling operations can be performed to generate wireline logs and core samples from the wellbore. Stress and strain distributions along the wellbore are determined based on the wireline log data and core sample data from the wellbore. A reservoir displacement of a reservoir in the subsurface formation is determined based on the stress and strain distributions. The locations of potential failures of well casings in the wellbore are identified based on the stress and strain distributions and the reservoir displacement. A variable strength casing can be designed for the wellbore with higher strength casing in the locations of potential failure relative to casing in other locations in the wellbore.

During the casing design process, the burst pressure, tensile strength, and collapse resistance of the casing are typically considered. Changes in stresses acting on the casing due to changes in the reservoir during the life of the well can propagate deformations in the well casing, which are not captured by initial reservoir or casing conditions. Casing deformations can compromise a well's integrity and production rates from the well. Methods such as wireline logs, e.g., multi-finger caliper logs, can be used to detect casing deformations, which can lead to delays in hydrocarbon production processes and can result in costly workover and remediation operations if deformations are found.

Implementations of the systems and methods of this disclosure can provide various technical benefits. Specific weak points in the well casing are located and identified at the design stage preventing future failures of the well casing that would require costly workover operations to replace deformed or otherwise compromised casing. The inputs to the method include wireline logs and core sample data providing realistic modelling of the well location in the subsurface. In addition to pore pressure estimations and flow rates, the strength of the well casing is determined based on reservoir stress and displacement variations taking into account more than burst pressure, tensile strength and collapse resistance of the casing. Changes in stresses acting on the casing can change over the lifetime of the well resulting due to, for example, reservoir subsidence (e.g., gradual caving in or sinking). In the systems and methods of this disclosure, subsidence of the reservoir is accounted for at the design stage mitigating potential failures due to reservoir displacement. The method considers plasticity of the subsurface formation to generate more realistic models of the subsurface as compared with models not including plasticity. Using variable strength casings can reduce costs for the well casing by including high strength casings only at the locations with the highest stresses and including lower strength casings at other locations as compared with including high strength casings for the entire well. Strategically placing the high strength well casings reduces risks of premature failure of the well casing as well as reducing cost. The variable strength well casing provides targeted reinforcement of the most vulnerable sections of the wellbore more efficiently using materials and resources by not overengineering less vulnerable sections of the wellbore.

The details of one or more implementations of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic illustrating a wireline operation.

FIG. 2 is a flow chart of a method for designing variable strength well casings.

FIG. 3 is a schematic illustration of a mesh for a single well model.

FIG. 4 is a flow chart for a workflow for determining stiffness for a subsurface formation.

FIG. 5 is a table of parameters for determining reservoir displacement in a subsurface formation.

FIG. 6 is a plot of displacement of a center of a reservoir with overburden regions above the reservoir and underburden regions below the reservoir.

FIG. 7 is another plot of displacement of a center of a reservoir with overburden regions above the reservoir and underburden regions below the reservoir.

FIG. 8 is an illustration of a reservoir shape after experiencing compaction.

FIG. 9 is a schematic of a well trajectory in a subsurface formation.

FIG. 10 is a free-body diagram of a section of well casing.

FIG. 11 is a visualization showing deformations of a section of well casing subjected to reservoir stresses.

FIG. 12 illustrates hydrocarbon production operations that include field operations and computational operations.

FIG. 13 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes systems and methods for designing variable strength casings for a wellbore in a subsurface formation. A data processing system (e.g., a computer or control system) obtains wireline log data and core sample data from the wellbore. The data processing system determines stress and strain distributions along the wellbore based on the wireline log data and core sample data from the wellbore. The data processing system determines a reservoir displacement of a reservoir in the subsurface formation based on the stress and strain distributions. The data processing system identifies locations of potential failure of well casings in the wellbore based on the stress and strain distributions and the reservoir displacement. The data processing system determines a variable strength casing design for the wellbore with higher strength casing in the locations of potential failure relative to casing in other locations in the wellbore.

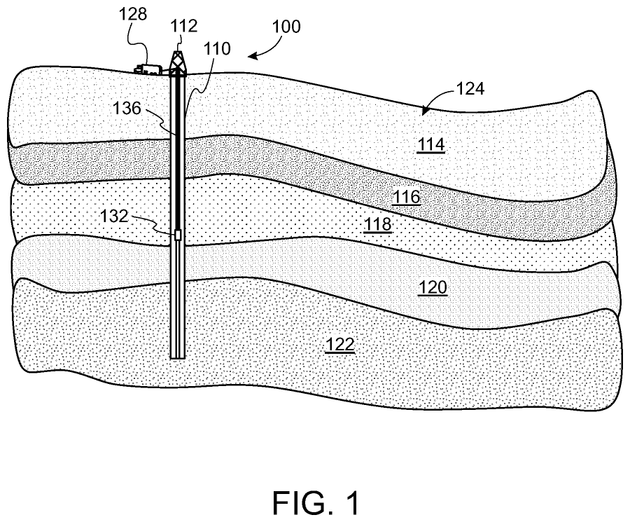

FIG. 1 illustrates a wireline operation 100 (e.g., a well logging operation) in which a wellbore 110 extends downhole from a wellhead 112. The wellbore 110 is a vertical wellbore but wireline operations can also be performed in other wellbores, for example, slanted or horizontal wellbores. In the wireline operation 100, the wellbore 110 penetrates through five layers 114, 116, 118, 120, 122 of a subsurface formation 124. A control truck 128 lowers a logging tool 132 (e.g., a sidewall coring tool) down the wellbore 110 on a wireline 136.

The logging tool 132 is a string of one or more instruments with sensors operable to measure petrophysical properties of the subsurface formation 124. For example, logging tools can include resistivity logs, borehole image logs, porosity logs, density logs, or sonic logs. Resistivity logs measure the subsurface electrical resistivity, which is the ability to impede the flow of electric current. These logs can help differentiate between formations filled with salty waters (good conductors of electricity) and those filled with hydrocarbons (poor conductors of electricity). Porosity logs measure the fraction or percentage of pore volume in a volume of rock using acoustic or nuclear technology. Acoustic logs measure characteristics of sound waves propagated through the well-bore environment. Nuclear logs utilize nuclear reactions that take place in the downhole logging instrument or in the formation. Density logs measure the bulk density of a formation by bombarding it with a radioactive source and measuring the resulting gamma ray count after the effects of Compton scattering and photoelectric absorption. Sonic logs provide a formation interval transit time, which is typically a function of lithology and rock texture but particularly porosity. The logging tool includes a piezoelectric transmitter and receiver and the time taken for the sound wave to travel the fixed distance between the two is recorded as an interval transit time.

As the logging tool 132 travels downhole, measurements of formation properties are recorded to generate a well log. In the illustrated operation, the data are recorded at the control truck 128 in real-time. Real-time data are recorded directly against measured cable depth. In some well-logging operations, the data is recorded at the logging tool 132 and downloaded later. In this approach, the downhole data and depth data are both recorded against time. The two data sets are then merged using the common time base to create an instrument response versus depth log.

In the wireline operation 100, the well logging is performed on a wellbore 110 that has already been drilled. In some operations, well logging is performed in the form of logging while drilling techniques. In these techniques, the sensors are integrated into the drill string and the measurements are made in real-time, during drilling rather than using sensors lowered into a well after drilling.

Using a wireline coring tool, core samples can be obtained in addition to obtaining well logs. A core sample is a usually cylindrical piece of the subsurface formation that is removed by a special drill and brought to the surface. Core samples can be used to measure petrophysical properties of the subsurface formation such as grain size, porosity, and permeability. Core samples can also be used to measure geomechanical properties of the subsurface formation such as Young's modulus, Poisson's ratio, and shear modulus. Core samples can be taken from the sidewalls of a drilled well. When sidewall core samples are repeated along the length of the well, the properties measured from the core samples can be compared and correlated with well logging measurements.

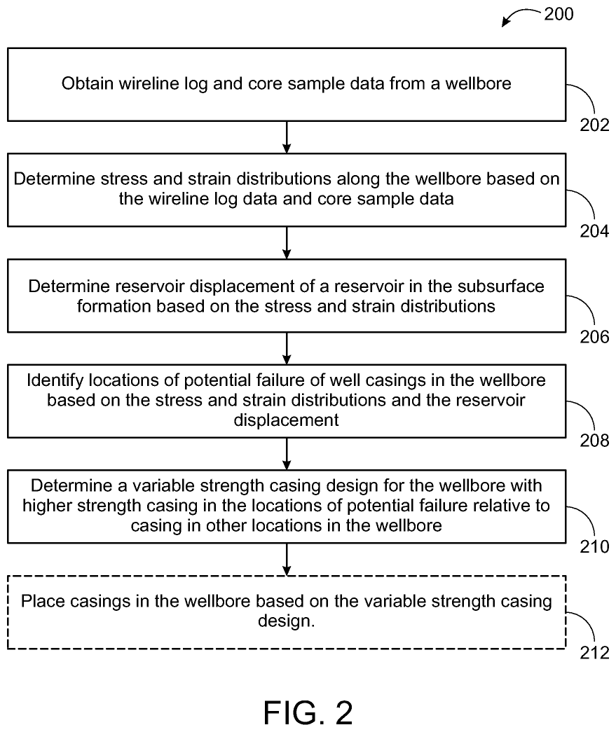

FIG. 2 is a flow chart of an example method 200 for designing variable strength well casing for a well in a subsurface formation. The method 200 can be implemented on a data processing system such as a computer or control system.

Properties of the subsurface formation can be measured by logging wells and/or taking core samples from the well. During well logging the data processing system can record data from the logging tools. Similarly, while analyzing core samples, the data processing system can record measurements taken from the core samples.

The data processing system obtains wireline log data and core sample data from the wellbore (step 202). For example, the data processing system records wireline log data and core sample data during a wireline operation (e.g., wireline operation 100). The wireline logs include, for example, one or more of a density log a compressional acoustic slowness log, and a shear acoustic slowness log. The core sample data includes, for example, one or more of density, porosity, permeability, Young's modulus, Poisson's ratio, reservoir compressibility, reservoir shear modulus, and unconfined compressive strength. In some implementations, the data processing system accesses the wireline log data and/or the core sample data from a data store.

The data processing system determines stress and strain distributions along the wellbore based on the wireline log data and core sample data (step 204). For example, the data processing system determines the stress and strain distributions using a three-dimensional poro-elasto-plastic geomechanics model. In some implementations, the geomechanics model is a finite element model and nodes of the three-dimensional finite element model include geomechanical properties derived from the wireline log data and the core sample data. The stress distribution can include body stresses and traction stresses on the wellbore resulting from loading of the wellbore structure. Sources of the loading include in-situ stresses from the geological formation, stresses from inside the wellbore due to hydrostatic pressure and frictional pressure losses of fluid within the wellbore, and expansion, compaction, or fault movements of the geological formation.

A poro-elasto-plastic geomechanics model offers several advantages over other models used in drilling engineering. Conventional models typically use linear elastic models relying on analytical solutions or simplified numerical solutions. Such simplified solutions inherit unrealistic assumptions resulting in inaccurate or unrealistic estimations of in situ stresses. The use of plasticity, in the geomechanics model, captures more realistic material behavior of the subsurface formation. Another advantage offered by this model over other numerical solutions is its calculation speed, which is fast enough to allow for a real-time/while-drilling implementation of the model. Factors that enable faster run times compared to other numerical models include a 3D mesh optimization which minimizes the number of grids, the 3D model size considers only a representative block of the geological formation and well as opposed to modeling the full reservoir/geological formation, and the solver used to solve the system of linear equations. The model used in this approach can be return a result within 30 seconds compared with other numerical models that can have a run time that extends into days.

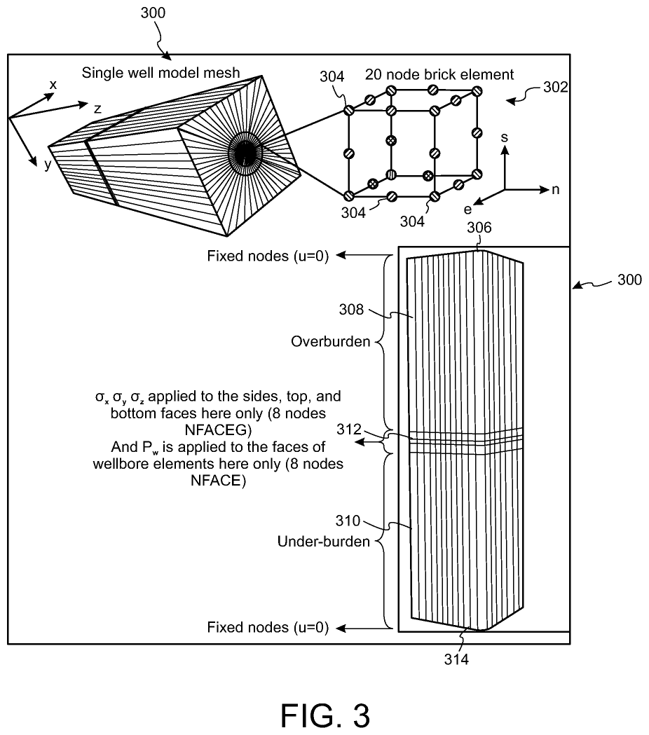

In some implementations, the geomechanics model applies a discretization using the minimization of the total potential energy of the 3D representative block of the geological formation and the well structure within it as illustrated in FIG. 3. The discretization decomposes the 3D representative block of the geological formation and the well structure into finite elements. The minimization of the total potential energy produces the following equilibrium:

$$u {\int }_{{V}^{e}} ( ( {B}^{T} ) D B ) d Ω = {\int }_{{V}^{e}} {N}^{T} F d Ω - {\int }_{{S}^{e}} {N}^{T} T d Γ , \qquad 1 )$$

where u is the displacement, B and B′ are the strain-displacement matrix and its transpose, respectively. NT is the transpose of the quadratic Serendipity shape functions vector, which are derived, for example, for a 20-node isoperimetric brick element, D is the consistent tangent matrix, which is formulated based on mechanical properties of the rock, F is the body force, and T is the traction force. The body and traction forces reflect the in-situ stresses and mud weight loading on the wellbore. The integrations in this equation are performed at the element volume (V^{e}) with respect to the volume variable (Ω) or at the element surface (S^{e}) with respect to the area variable (Γ). The matrix resulting from the integral in the expression on the left hand side of equation 1 is known as the stiffness matrix (K^{e}).

The geomechanics model uses a plastic flow rule for strain hardening or strain softening to reflect the plastic behavior of the rock, which occurs beyond the yield point. For example, the total strain is the addition of two components, which are poro-elastic strain (ε^{e}) and a plastic strain (ε^{p}). The plastic flow rule assumes that the flow direction is perpendicular to the vied surface ψ:

$$Δ {ε}_{i j}^{p} = λ \frac{\partial ψ ( {σ}_{i j} )}{\partial {σ}_{i j}} , \qquad ( 2 )$$

where εᵢⱼ^{p} is the plastic strain tensor, σᵢⱼ is the stress tensor, and A is the plastic strain multiplier. The associative flow rule is applied by assuming that the plastic potential surface is the same as the yield surface ψ. It also assumes the yield surface expands without changing the flow direction. An example of a yield criterion in the geomechanics model is the Drucker-Prager criterion, where yielding will take place when the deviatoric stress tensor (Sᵢⱼ) and the mean stress (σₘ) satisfy the following relationship:

$$ψ ( {σ}_{ij} ) = \sqrt{\frac{1}{2} {S}_{i j} {S}_{i j}} - {a}_{0} + {a}_{1} {σ}_{m} = 0 , \qquad ( 3 )$$

where constants a₀ and a₁ are determined experimentally as material properties and are used to correlate the Drucker-Prager criterion to the Mohr-Coulomb criterion.

The following expression for strain hardening can then be used to calculate the scalar plastic strain ε^{p} from the plastic strain tensor determined by the flow rule:

$${ε}^{p} = \int \sqrt{\frac{2}{3} d {ε}_{i j}^{p} d {ε}_{i j}^{p}} . \qquad ( 4 )$$

The data processing system determines a reservoir displacement of a reservoir in the subsurface formation based on the stress and strain distributions (step 206). In some implementations, the data processing system determines reservoir displacement by simulating hydrocarbon production from the reservoir using a reservoir simulator.

Both the compaction and expansion of a reservoir can be significant geological and engineering considerations in the context of natural resources and energy extraction. Reservoir depletion refers, for example, to the gradual reduction of the reservoir's fluid content, such as oil or gas, as it is produced over time. This process leads to decreased reservoir pressure and lower production rates. Compaction or expansion relates to the subsurface movements and changes that occur within the reservoir as fluid is extracted or injected. As fluids are withdrawn, the porous rock formation can compact, leading to subsidence of the surface above. Conversely, injection processes can cause expansion and potential uplift of the formation. Managing the compaction and expansion effects can be important for sustainable resource extraction, minimizing environmental impacts, and ensuring long term productivity of the reservoir. The displacement of subsurface formations or reservoirs as a result of compaction or expansion can impact the structural integrity of casing strings and cement sheaths that are bonded and attached to these formations. The estimation of formation displacement throughout the life cycle of a well can be important for determining both the magnitude and localization of potential pipe deformation.

There are several methods to determine formation displacement. For example, formation displacement can be determined using a reservoir simulator or geomechanics model. Simulating the subsurface formation displacement includes considering pore pressure changes over time (either due to injection or depletion) in the 3D model. Alternatively, or additionally, the formation displacement can be estimated using an analytical solution. An example of an analytical solution is shown in equation 5 where the uniaxial compressibility (cₘ) is initially calculated using Young's Modulus (E) and Poisson's Ratio (v) determined through core sample tests,

$${c}_{m} = \frac{( 1 + v ) ( 1 - 2 v )}{E ( 1 - v )} . \qquad ( 5 )$$

In some implementations, the solution of Geertsma 1973a (Geertsma, J. “Land subsidence above compacting oil and gas reservoirs.” Journal of Petroleum Technology 25, no. 06 (1973): 734-744) is used to determine the formation subsidence. The Geertsma 1973a solution considers the geometric properties (e.g. areal extent and reservoir thickness), planned pressure depletion, and relevant rock mechanics properties (e.g., reservoir compressibility and Poisson's ratio). According to this solution, the surface subsidence (u_{z}) at the land surface or seabed can be computed by considering the pressure depletion (ΔP) at depth (D) and the radial distance (r). Uniaxial compressibility (cₘ) and Poisson's Ratio (v) are utilized in a nucleus-of-strain approach, with the nucleus representing an infinitesimal volume where the depletion is applied, as described in equation 6. The total subsidence can be calculated using:

$${u}_{z} ( r , 0 ) = - \frac{1}{π} {c}_{m} ( 1 - v ) \frac{D}{{( {r}^{2} + {D}^{2} )}^{1.5}} Δ PV . \qquad ( 6 )$$

Geertsma 1973b (Geertsma, J. “A basic theory of subsidence due to reservoir compaction; the homogeneous case.” (1973)) also provides a numerical approximation of the subsidence at any subsurface point within a finite volume (V) using equation 7. Here, R₁ and R₂ represent the distances between the point of interest and the nucleus of strain and the image point of the nucleus of strain (above ground surface by magnitude D), respectively, and \hat{z} denotes the unit vector in the z-direction.

$${u}_{z} ( r , 0 ) = - Δ p V \frac{{c}_{m}}{4 π} \{ \frac{{R}_{z 1}}{{R}_{1}^{3}} + ( 3 - 4 v ) \frac{{R}_{z 2}}{{R}_{2}^{3}} - 6 z ( z + D ) \frac{{R}_{z 2}}{{R}_{2}^{5}} + \frac{2 \hat{z}}{{R}_{1}^{3}} [ ( 3 - 4 v ) ( z + D ) - z ] \} \qquad ( 7 )$$

The data processing system identifies locations of potential failure of well casings in the wellbore based on the stress and strain distributions and the reservoir displacement (step 210). For example, the data processing system identifies locations along a trajectory of the wellbore having higher stress states relative to other stress states along the trajectory of the wellbore. In some implementations, the data processing system identifies locations of potential failure based on locations having a larger reservoir displacement relative to reservoir displacement at other locations.

The data processing system determines a variable strength casing design for the wellbore with higher strength casing in the locations of potential failure relative to casing in other locations in the wellbore (step 212). For example, the data processing system determines a wall thickness for the casing that can withstand the determined stresses, strains, and reservoir displacements at the identified locations of potential failure. In some implementations, the data processing system selects casing sizes from a set of standard casing sizes.

In some implementations, the method 200 includes placing casings in the wellbore based on the variable strength casing design (step 214). For example, the data processing system can generate control commands to control equipment to install casings in the wellbore based on the variable strength casing design.

FIG. 3 is a schematic of an example single well model mesh 300 that can be used in a geomechanical model to design variable strength casings for a wellbore. The model mesh 300 includes brick elements 302 such as 20-node isoperimetric brick elements. The brick elements 302 can be cuboids (as shown) and other shapes are also possible (e.g., tetrahedrons, hexagonal prisms, etc.). The nodes 304 of the brick elements can be assigned properties of the formation (e.g., geomechanical properties derived from well log data and/or core sample data). The properties of the formation assigned to the nodes 304 can vary based on variation in the subsurface formation being modeled (e.g., the distribution of properties can be heterogeneous). At the top 306 of the model mesh 300, a fixed boundary condition (e.g., no displacement) is applied to the nodes. The upper portion 308 of the model mesh 300 includes regions of overburden. The lower portion 310 of the model mesh 300 includes regions of underburden. The middle portion 312 of the model mesh 300 includes the reservoir portion of the subsurface formation. Normal stresses are applied to the side, top, and bottom faces of the brick elements 302 in the middle portion 312. Pw values are also applied to the faces of the brick elements 302 in the middle portion 312. Pw represents the inside wellbore stresses that results from hydrostatic pressure and frictional pressure losses of the wellbore fluids. The At the bottom 314 of the model mesh 300, a fixed boundary condition is applied to the nodes. NFACEG represents the surfaces of the finite elements that are exposed to outer boundary within the geological formation. NFACE represents the surfaces of the finite elements that are exposed to the inside of the wellbore.

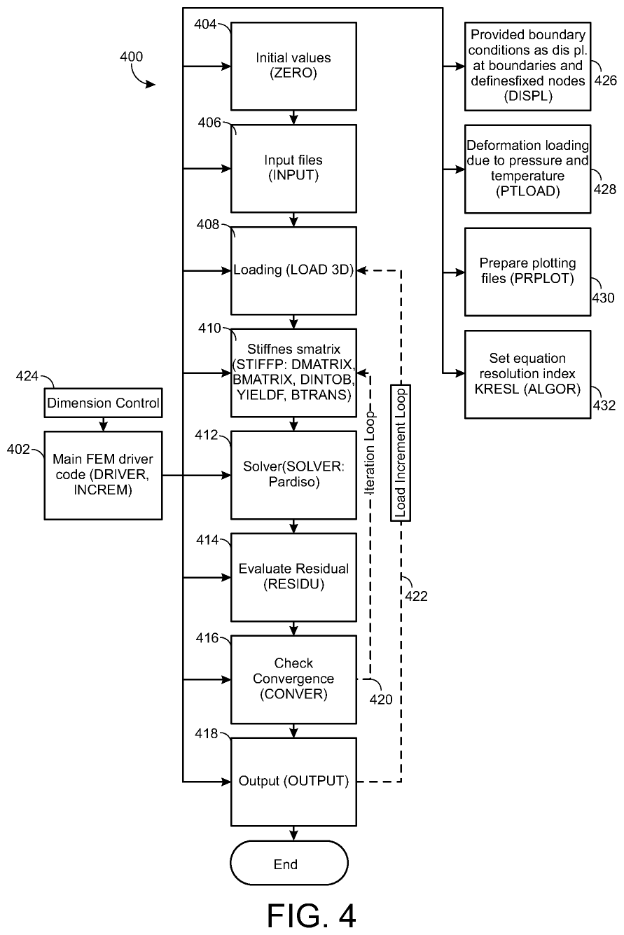

FIG. 4 is an example workflow 400 for modeling a subsurface formation. In an example implementation of a geomechanics model solved using a finite element method (FEM), the FEM is implemented through 33 subroutines and a driver code 402. The driver code 402 calls twelve main subroutines that perform several functions including initializing (404) values, receiving (406) the input file, applying (408) loads to the mesh, constructing (410) the global stiffness matrix, and solving (412) the system of equations.

After solving (412) the system of equations, e.g., as described by Equation (1), and determining the displacements u, the data processing system calculates (414) residual forces to check (416) for convergence and equilibrium by subtracting the left-hand side of the system of equations from the right-hand side in the global form, where the left-hand side is the global stiffness matrix multiplied by displacement and the right-hand side is the body and traction forces. The value obtained from the subtraction of these two quantities should be equal to zero if the equilibrium condition is fully satisfied. However, that is not always achievable, therefore, a tolerance value is set to check for convergence. For example, the tolerance value is set to be close to but not equal to zero. Once the residual forces are calculated and found to be less than the set tolerance value the data processing system determines that convergence is achieved, and outputs (418) the results. Otherwise, the residual forces are carried to the next iteration of steps 410-416. Steps 408-418 can be repeated for separate load increments, where the load increments are defined in the input file manually. These processes are carried out in two loops with the convergence loop 420 nested in the load increment loop 422. The driver code 402 also includes routines for dimension control 424, displaying (426) boundary conditions, deformation loading (428) due to effects of pressure and temperature, preparing (430) plotting files, and setting (432) an equation resolution index.

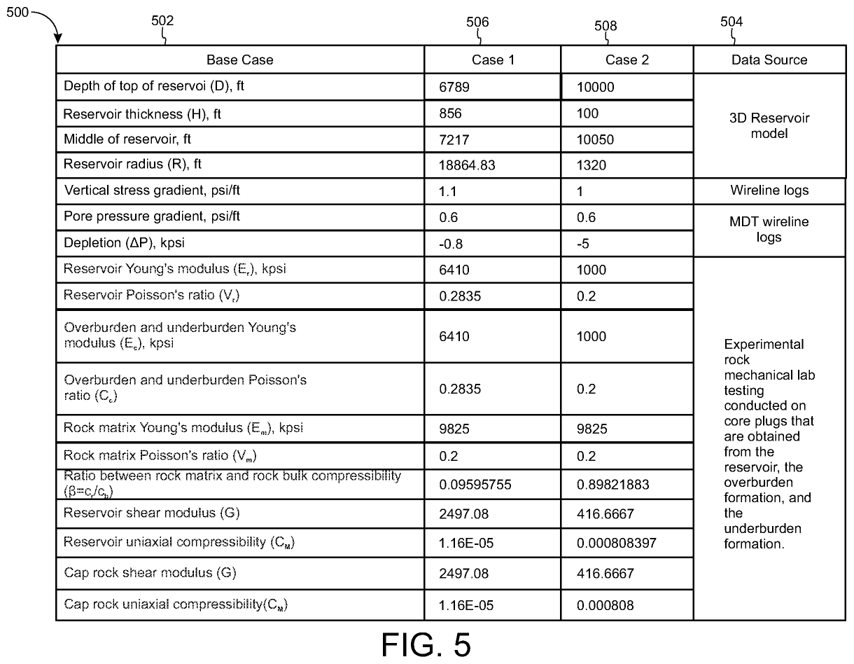

FIG. 5 is a table 500 showing example variables 502 used for determining displacement (e.g., compaction) of a subsurface formation. Sources 504 of the variables 502 and two sets of example values 506, 508 for the variables 502 are also shown. The variables 502 and values 506, 508 can be used in conjunction with equations 5, 6, and/or 7 to determine displacement of the reservoir.

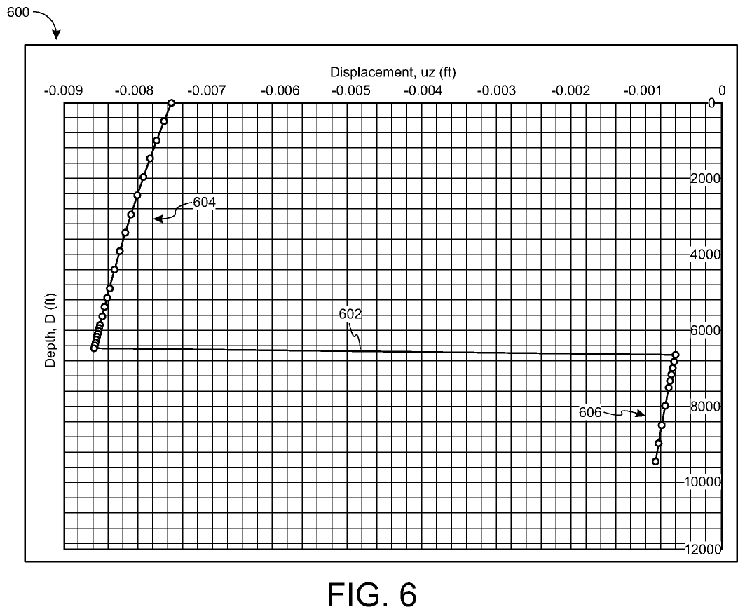

FIG. 6 is a plot 600 of reservoir subsidence for an example reservoir. The plot 600 shows the displacement of the center of the formation as a function of depth. To illustrate the extent of displacement along the reservoir section, results were plotted after conducting the required calculations for compaction using values 506 shown in table 500. The reservoir is assumed to be disc-shaped for the purpose of calculating the reservoir volume. After compaction, the reservoir's shape transformed into a compacted bowl shape. The center of reservoir section 602 encountered a subsidence of approximately 0.08 ft (˜1 in). The overburden 604 and underburden 606 formation sections did not undergo any compaction. However, due to the subsidence of the reservoir zone, the center of both overburden 604 and underburden 606 formations shifted downward.

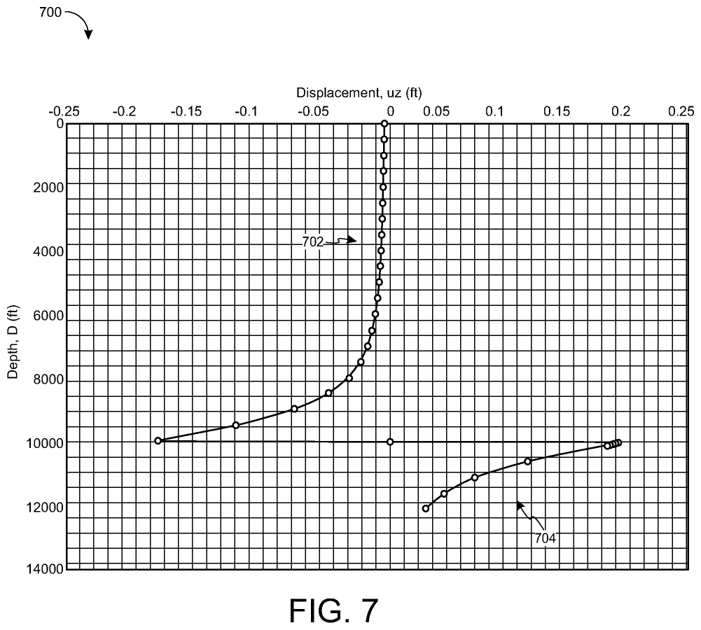

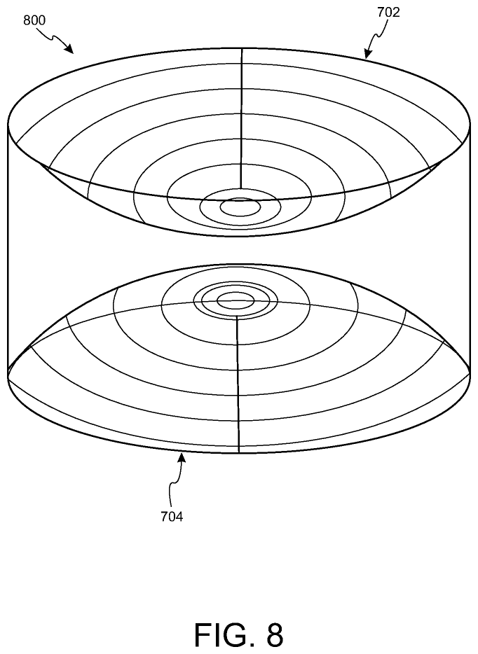

FIGS. 7 and 8 show reservoir subsidence based on the variable values 508 from table 500. FIG. 7 shows a plot 700, and FIG. 8 shows a three dimensional rendering 800. The subsidence behavior in plot 700 is different than the situation in plot 600. In this case, depending on the mechanical properties of each layer, the overburden formations 702 shift downward while the underburden formations 704 shift upwards simultaneously forming a downward concave shape in the overburden formations 702 and a concave upward shape in the underburden formations 704.

Equations 5-7 used for FIGS. 6-8 can be utilized for calculating expansion as well as compaction. In the case of expansion, the formation will behave differently than when there is compaction. With water injection, for example, the increase in formation pore pressure would expand the reservoir section. Consequently, the center of overburden formations will be shifted upward, while the center of underburden formations can experience a downward displacement.

During drilling operations, various forces and stresses act upon the wellbore, which can originate, for example, from in-situ stresses of the formation or from forces imposed by the drilling fluid. If these stresses exceed the casing's yield strength, the forces can lead to deformations of the casing that can require expensive remedial jobs to repair the casing string. Identifying potential weak points in the wellbore before placing the casing can reduce risks and avoid potential failures.

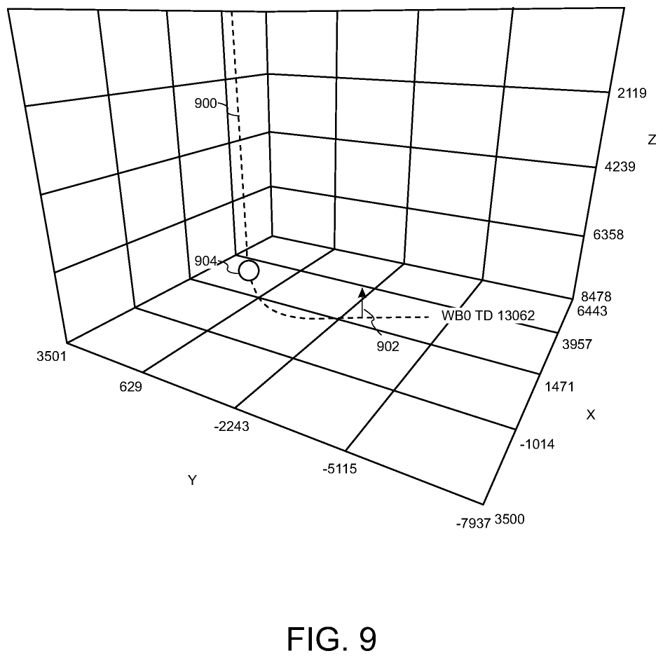

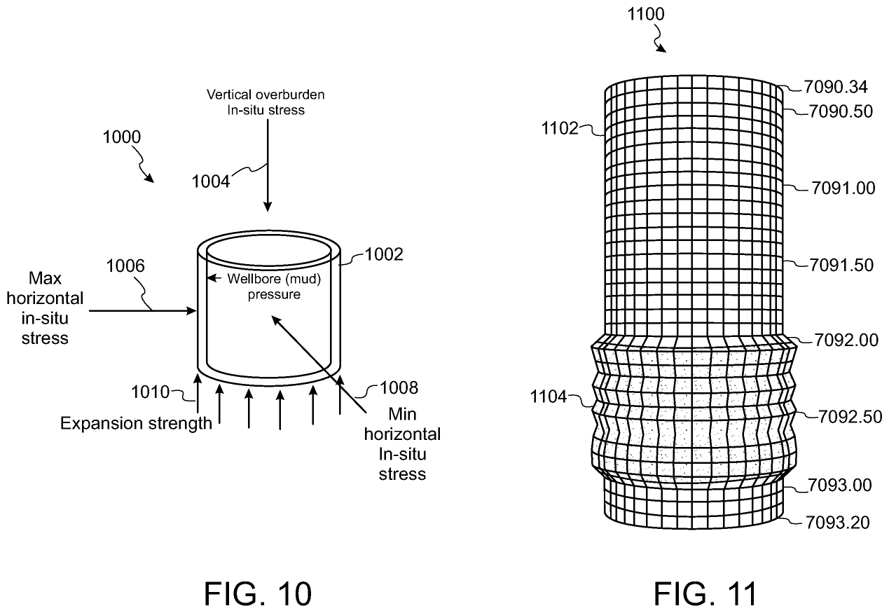

FIG. 9 illustrates a trajectory 900 for an injector well. The arrow 902 indicates the direction of reservoir expansion along the z-axis. The wellbore experiences five distinct loads: three principal in-situ stresses, internal wellbore fluid pressure, and expansion stress. These stresses are depicted schematically in the free body diagram of FIG. 10.

The data processing system considers the trajectory 900 of the wellbore and calculates the stresses encountered at each point enabling identification of the locations along the wellbore that are prone to casing deformation at the design phase. In the trajectory 900, the data processing system identified the kick-off point 904 (e.g., the point at which a directional well deviates from vertical) as the weakest spot along the trajectory. Accordingly, the data processing system can determine a design to place higher strength casing at this location to avoid deformation of the casing. By proactively addressing weak points, the risk of costly casing failures can be significantly reduced, enhancing the overall efficiency and safety of wellbore operations.

FIG. 10 is an example free-body diagram 1000 illustrating the stresses experienced by casing 1002 in a wellbore. The casing 1002 experiences three principal in situ stresses: vertical overburden stress 1004, maximum horizontal in situ stress 1006, and minimum horizontal in situ stress 1008. The casing 1002 also experiences expansion stresses 1010 caused by expansion of the reservoir, and wellbore pressure stresses 1012 from fluids in the wellbore (e.g., mud, oil, gas, etc.).

FIG. 11 is a visualization 1100 of casing deformation as a result of stresses exceeding a yield limit of the casing 1102. For example, at the kick-off point 904, the stresses can exceed a nominal yield limit of casing in the wellbore. The visualization 1100 shows buckling 1104 where the casing 1102 fails. When deformation such as buckling 1104 is localized in the casing 1102. It can be more efficient to strengthen the casing at the identified weak location (e.g., high stress location) in the wellbore as compared with strengthening all of the casing in the well bore.

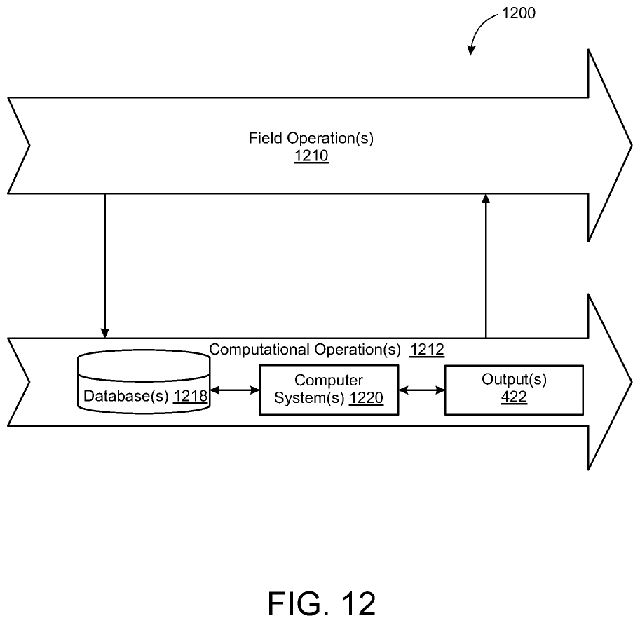

FIG. 12 illustrates hydrocarbon production operations 1200 that include both one or more field operations 1210 and one or more computational operations 1212, which exchange information and control exploration for the production of hydrocarbons. In some implementations, outputs of techniques of the present disclosure (e.g., the method 300) can be performed before, during, or in combination with the hydrocarbon production operations 1200, specifically, for example, either as field operations 1210 or computational operations 1212, or both. For example, the method 300 collects data during field operations, processes the data in computational operations, and can determine locations to perform additional field operations.

Examples of field operations 1210 include forming/drilling a wellbore, hydraulic fracturing, producing through the wellbore, injecting fluids (such as water) through the wellbore, to name a few. In some implementations, methods of the present disclosure can trigger or control the field operations 1210. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1210 and responsively triggering the field operations 1210 including, for example, generating plans and signals that provide feedback to and control physical components of the field operations 1210. Alternatively or in addition, the field operations 1210 can trigger the methods of the present disclosure. For example, implementing physical components (including, for example, hardware, such as sensors) deployed in the field operations 1210 can generate plans and signals that can be provided as input or feedback (or both) to the methods of the present disclosure.

Examples of computational operations 1212 include one or more computer systems 1220 that include one or more processors and computer-readable media (e.g., non-transitory computer-readable media) operatively coupled to the one or more processors to execute computer operations to perform the methods of the present disclosure. The computational operations 1212 can be implemented using one or more databases 1218, which store data received from the field operations 1210 and/or generated internally within the computational operations 1212 (e.g., by implementing the methods of the present disclosure) or both. For example, the one or more computer systems 1220 process inputs from the field operations 1210 to assess conditions in the physical world, the outputs of which are stored in the databases 1218. For example, seismic sensors of the field operations 1210 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1212 where they are stored in the databases 1218 and analyzed by the one or more computer systems 1220.

In some implementations, one or more outputs 1222 generated by the one or more computer systems 1220 can be provided as feedback/input to the field operations 1210 (either as direct input or stored in the databases 1218). The field operations 1210 can use the feedback/input to control physical components used to perform the field operations 1210 in the real world.

For example, the computational operations 1212 can process the seismic data to generate three-dimensional (3D) maps of the subsurface formation. The computational operations 1212 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1212 to process new information about the formation and control the drilling to adjust to the observed conditions in real-time.

The one or more computer systems 1220 can update the 3D maps of the subsurface formation as information from one exploration well is received and the computational operations 1212 can adjust the location of the next exploration well based on the updated 3D maps. Similarly, the data received from production operations can be used by the computational operations 1212 to control components of the production operations. For example, production well and pipeline data can be analyzed to predict slugging in pipelines leading to a refinery and the computational operations 1212 can control machine operated valves upstream of the refinery to reduce the likelihood of plant disruptions that run the risk of taking the plant offline.

In some implementations of the computational operations 1212, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

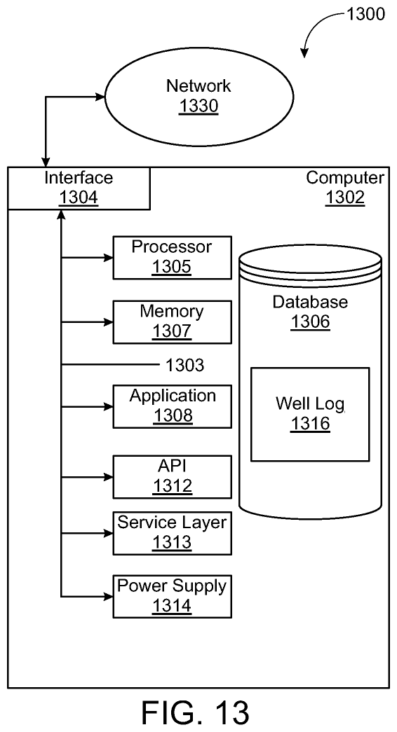

FIG. 13 is a block diagram of an example computer system 1300 used to provide computational functionalities associated with described algorithms, methods, functions, processes, flows, and procedures described in the present disclosure, according to some implementations of the present disclosure. The illustrated computer 1302 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 1302 can include input devices such as keypads, keyboards, and touch screens that can accept user information. Also, the computer 1302 can include output devices that can convey information associated with the operation of the computer 1302. The information can include digital data, visual data, audio information, or a combination of information. The information can be presented in a graphical user interface (UI) (or GUI).

The computer 1302 can serve in a role as a client, a network component, a server, a database, a persistency, or components of a computer system for performing the subject matter described in the present disclosure. The illustrated computer 1302 is communicably coupled with a network 1330. In some implementations, one or more components of the computer 1302 can be configured to operate within different environments, including cloud-computing-based environments, local environments, global environments, and combinations of environments.

At a high level, the computer 1302 is an electronic computing device operable to receive, transmit, process, store, and manage data and information associated with the described subject matter. According to some implementations, the computer 1302 can also include, or be communicably coupled with, an application server, an email server, a web server, a caching server, a streaming data server, or a combination of servers.

The computer 1302 can receive requests over network 1330 from a client application (for example, executing on another computer 1302). The computer 1302 can respond to the received requests by processing the received requests using software applications. Requests can also be sent to the computer 1302 from internal users (for example, from a command console), external (or third) parties, automated applications, entities, individuals, systems, and computers.

Each of the components of the computer 1302 can communicate using a system bus 1303. In some implementations, any or all of the components of the computer 1302, including hardware or software components, can interface with each other or the interface 1304 (or a combination of both), over the system bus 1303. Interfaces can use an application programming interface (API) 1312, a service layer 1313, or a combination of the API 1312 and service layer 1313. The API 1312 can include specifications for routines, data structures, and object classes. The API 1312 can be either computer-language independent or dependent. The API 1312 can refer to a complete interface, a single function, or a set of APIs.

The service layer 1313 can provide software services to the computer 1302 and other components (whether illustrated or not) that are communicably coupled to the computer 1302. The functionality of the computer 1302 can be accessible for all service consumers using this service layer. Software services, such as those provided by the service layer 1313, can provide reusable, defined functionalities through a defined interface. For example, the interface can be software written in JAVA, C++, or a language providing data in extensible markup language (XML) format. While illustrated as an integrated component of the computer 1302, in alternative implementations, the API 1312 or the service layer 1313 can be stand-alone components in relation to other components of the computer 1302 and other components communicably coupled to the computer 1302. Moreover, any or all parts of the API 1312 or the service layer 1313 can be implemented as child or sub-modules of another software module, enterprise application, or hardware module without departing from the scope of the present disclosure.

The computer 1302 includes an interface 1304. Although illustrated as a single interface 1304 in FIG. 13, two or more interfaces 1304 can be used according to particular needs, desires, or particular implementations of the computer 1302 and the described functionality. The interface 1304 can be used by the computer 1302 for communicating with other systems that are connected to the network 1330 (whether illustrated or not) in a distributed environment. Generally, the interface 1304 can include, or be implemented using, logic encoded in software or hardware (or a combination of software and hardware) operable to communicate with the network 1330. More specifically, the interface 1304 can include software supporting one or more communication protocols associated with communications. As such, the network 1330 or the interface's hardware can be operable to communicate physical signals within and outside of the illustrated computer 1302.

The computer 1302 includes a processor 1305. Although illustrated as a single processor 1305 in FIG. 13, two or more processors 1305 can be used according to particular needs, desires, or particular implementations of the computer 1302 and the described functionality. Generally, the processor 1305 can execute instructions and can manipulate data to perform the operations of the computer 1302, including operations using algorithms, methods, functions, processes, flows, and procedures as described in the present disclosure.

The computer 1302 also includes a database 1306 that can hold data for the computer 1302 and other components connected to the network 1330 (whether illustrated or not). For example, database 1306 can be an in-memory, conventional, or a database storing data consistent with the present disclosure. In some implementations, database 1306 can be a combination of two or more different database types (for example, hybrid in-memory and conventional databases) according to particular needs, desires, or particular implementations of the computer 1302 and the described functionality. Although illustrated as a single database 1306 in FIG. 13, two or more databases (of the same, different, or combination of types) can be used according to particular needs, desires, or particular implementations of the computer 1302 and the described functionality. While database 1306 is illustrated as an internal component of the computer 1302, in alternative implementations, database 1306 can be external to the computer 1302.

The computer 1302 also includes a memory 1307 that can hold data for the computer 1302 or a combination of components connected to the network 1330 (whether illustrated or not). Memory 1307 can store any data consistent with the present disclosure. In some implementations, memory 1307 can be a combination of two or more different types of memory (for example, a combination of semiconductor and magnetic storage) according to particular needs, desires, or particular implementations of the computer 1302 and the described functionality. Although illustrated as a single memory 1307 in FIG. 13, two or more memories 1307 (of the same, different, or combination of types) can be used according to particular needs, desires, or particular implementations of the computer 1302 and the described functionality. While memory 1307 is illustrated as an internal component of the computer 1302, in alternative implementations, memory 1307 can be external to the computer 1302.

The application 1308 can be an algorithmic software engine providing functionality according to particular needs, desires, or particular implementations of the computer 1302 and the described functionality. For example, application 1308 can serve as one or more components, modules, or applications. Further, although illustrated as a single application 1308, the application 1308 can be implemented as multiple applications 1308 on the computer 1302. In addition, although illustrated as internal to the computer 1302, in alternative implementations, the application 1308 can be external to the computer 1302.

The computer 1302 can also include a power supply 1314. The power supply 1314 can include a rechargeable or non-rechargeable battery that can be configured to be either user- or non-user-replaceable. In some implementations, the power supply 1314 can include power-conversion and management circuits, including recharging, standby, and power management functionalities. In some implementations, the power-supply 1314 can include a power plug to allow the computer 1302 to be plugged into a wall socket or a power source to, for example, power the computer 1302 or recharge a rechargeable battery.

There can be any number of computers 1302 associated with, or external to, a computer system containing computer 1302, with each computer 1302 communicating over network 1330. Further, the terms “client,” “user,” and other appropriate terminology can be used interchangeably, as appropriate, without departing from the scope of the present disclosure. Moreover, the present disclosure contemplates that many users can use one computer 1302 and one user can use multiple computers 1302.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of implementations of these systems and methods have been described. Nevertheless, it will be understood that various modifications may be made without departing from the spirit and scope of this disclosure. Accordingly, other implementations are within the scope of the following claims.

### Examples

In an example implementation, a method for designing variable strength casings for a wellbore in a subsurface formation includes obtaining wireline log data and core sample data from the wellbore; determining stress and strain distributions along the wellbore based on the wireline log data and core sample data; determining reservoir displacement of a reservoir in the subsurface formation based on the stress and strain distributions; identifying locations of potential failure of well casings in the wellbore based on the stress and strain distributions and the reservoir displacement; and determining a variable strength casing design for the wellbore with higher strength casing in the locations of potential failure relative to casing in other locations in the wellbore.

An aspect combinable with the example implementation includes placing casings in the wellbore based on the variable strength casing design.

In another aspect combinable with any of the previous aspects the wireline log data includes one or more of a density log, a compressional acoustic slowness log, and a shear acoustic slowness log.

Another aspect combinable with any of the previous aspects includes determining stress and strain distributions based on a poro-elasto-plastic geomechanics model.

In another aspect combinable with any of the previous aspects, the poro-elasto-plastic geomechanics model includes a three-dimensional finite element model.

In another aspect combinable with any of the previous aspects, nodes of the three-dimensional finite element model include geomechanical properties derived from the wireline log data and the core sample data.

In another aspect combinable with any of the previous aspects, the poro-elasto-plastic geomechanics model is discretized based on a minimization of total potential energy.

In another aspect combinable with any of the previous aspects, identifying locations of potential failure includes identifying locations along a trajectory of the wellbore having higher stress states relative to other stress states along the trajectory of the wellbore.

In another aspect combinable with any of the previous aspects, determining reservoir displacement includes simulating hydrocarbon production from the reservoir using a reservoir simulator.

In another aspect combinable with any of the previous aspects, the stress distribution includes body stresses and traction stresses on the wellbore.

In another example implementation, a system for designing variable strength casings for a wellbore in a subsurface formation includes at least one processor and a memory storing instructions that when executed by the at least one processor cause the at least one processor to perform operations including obtaining wireline log data and core sample data from the wellbore; determining stress and strain distributions along the wellbore based on the wireline log data and core sample data; determining reservoir displacement of a reservoir in the subsurface formation based on the stress and strain distributions; identifying locations of potential failure of well casings in the wellbore based on the stress and strain distributions and the reservoir displacement; and determining a variable strength casing design for the wellbore with higher strength casing in the locations of potential failure relative to casing in other locations in the wellbore.

In an aspect combinable with the example implementation, the operations include placing casings in the wellbore based on the variable strength casing design.

In another aspect combinable with any of the previous aspects, determining stress and strain distributions is based on a poro-elasto-plastic geomechanics model.

In another aspect combinable with any of the previous aspects, the poro-elasto-plastic geomechanics model includes a three-dimensional finite element model, wherein nodes of the three-dimensional finite element model include geomechanical properties derived from the wireline log data and the core sample data.

In another aspect combinable with any of the previous aspects, identifying locations of potential failure includes identifying locations along a trajectory of the wellbore having higher stress states relative to other stress states along the trajectory of the wellbore.

In another aspect combinable with any of the previous aspects, determining reservoir displacement includes simulating hydrocarbon production from the reservoir using a reservoir simulator.

In another example implementation, one or more non-transitory, machine-readable storage devices storing instructions for designing variable strength casings for a wellbore in a subsurface formation, the instructions being executable by one or more processors, to cause performance of operations including obtaining wireline log data and core sample data from the wellbore; determining stress and strain distributions along the wellbore based on the wireline log data and core sample data; determining reservoir displacement of a reservoir in the subsurface formation based on the stress and strain distributions; identifying locations of potential failure of well casings in the wellbore based on the stress and strain distributions and the reservoir displacement; and determining a variable strength casing design for the wellbore with higher strength casing in the locations of potential failure relative to casing in other locations in the wellbore.

In an aspect combinable with the example implementation, determining stress and strain distributions is based on a poro-elasto-plastic geomechanics model.

In another aspect combinable with any of the previous aspects, the poro-elasto-plastic geomechanics model includes a three-dimensional finite element model, where nodes of the three-dimensional finite element model include geomechanical properties derived from the wireline log data and the core sample data.

In another aspect combinable with any of the previous aspects, identifying locations of potential failure includes identifying locations along a trajectory of the wellbore having higher stress states relative to other stress states along the trajectory of the wellbore.

What is claimed is:

1. A method for designing variable strength casings for a wellbore in a subsurface formation, the method comprising:
obtaining wireline log data and core sample data from the wellbore;
determining stress and strain distributions along the wellbore based on the wireline log data and core sample data;
determining reservoir displacement of a reservoir in the subsurface formation based on the stress and strain distributions;
identifying locations of potential failure of well casings in the wellbore based on the stress and strain distributions and the reservoir displacement; and
determining a variable strength casing design for the wellbore with higher strength casing in the locations of potential failure relative to casing in other locations in the wellbore.

2. The method of claim 1, further comprising:
placing casings in the wellbore based on the variable strength casing design.

3. The method of claim 1, wherein the wireline log data comprises one or more of a density log, a compressional acoustic slowness log, and a shear acoustic slowness log.

4. The method of claim 1, wherein determining stress and strain distributions is based on a poro-elasto-plastic geomechanics model.

5. The method of claim 4, wherein the poro-elasto-plastic geomechanics model comprises a three-dimensional finite element model.

6. The method of claim 5, wherein nodes of the three-dimensional finite element model comprise geomechanical properties derived from the wireline log data and the core sample data.

7. The method of claim 4, wherein the poro-elasto-plastic geomechanics model is discretized based on a minimization of total potential energy.

8. The method of claim 1, wherein identifying locations of potential failure comprises identifying locations along a trajectory of the wellbore having higher stress states relative to other stress states along the trajectory of the wellbore.

9. The method of claim 1, wherein determining reservoir displacement comprises simulating hydrocarbon production from the reservoir using a reservoir simulator.

10. The method of claim 1, wherein the stress distribution comprises body stresses and traction stresses on the wellbore.

11. A system for designing variable strength casings for a wellbore in a subsurface formation, the system comprising:
at least one processor and a memory storing instructions that when executed by the at least one processor cause the at least one processor to perform operations comprising:
obtaining wireline log data and core sample data from the wellbore;
determining stress and strain distributions along the wellbore based on the wireline log data and core sample data;
determining reservoir displacement of a reservoir in the subsurface formation based on the stress and strain distributions;
identifying locations of potential failure of well casings in the wellbore based on the stress and strain distributions and the reservoir displacement; and
determining a variable strength casing design for the wellbore with higher strength casing in the locations of potential failure relative to casing in other locations in the wellbore.

12. The system of claim 11, further comprising:
placing casings in the wellbore based on the variable strength casing design.

13. The system of claim 11, wherein determining stress and strain distributions is based on a poro-elasto-plastic geomechanics model.

14. The system of claim 13, wherein the poro-elasto-plastic geomechanics model comprises a three-dimensional finite element model, wherein nodes of the three-dimensional finite element model comprise geomechanical properties derived from the wireline log data and the core sample data.

15. The system of claim 11, wherein identifying locations of potential failure comprises identifying locations along a trajectory of the wellbore having higher stress states relative to other stress states along the trajectory of the wellbore.

16. The system of claim 11, wherein determining reservoir displacement comprises simulating hydrocarbon production from the reservoir using a reservoir simulator.

17. One or more non-transitory, machine-readable storage devices storing instructions for designing variable strength casings for a wellbore in a subsurface formation, the instructions being executable by one or more processors, to cause performance of operations comprising:
obtaining wireline log data and core sample data from the wellbore;
determining stress and strain distributions along the wellbore based on the wireline log data and core sample data;
determining reservoir displacement of a reservoir in the subsurface formation based on the stress and strain distributions;
identifying locations of potential failure of well casings in the wellbore based on the stress and strain distributions and the reservoir displacement; and
determining a variable strength casing design for the wellbore with higher strength casing in the locations of potential failure relative to casing in other locations in the wellbore.

18. The one or more non-transitory, machine-readable storage devices of claim 17, wherein determining stress and strain distributions is based on a poro-elasto-plastic geomechanics model.

19. The one or more non-transitory, machine-readable storage devices of claim 18, wherein the poro-elasto-plastic geomechanics model comprises a three-dimensional finite element model, wherein nodes of the three-dimensional finite element model comprise geomechanical properties derived from the wireline log data and the core sample data.

20. The one or more non-transitory, machine-readable storage devices of claim 17, wherein identifying locations of potential failure comprises identifying locations along a trajectory of the wellbore having higher stress states relative to other stress states along the trajectory of the wellbore.
